(19) United States
(12) Patent Application Publication
(10) Pub. No.: US 2005/0166148 A1
(43) Pub. Date: Jul. 28, 2005

(54) Interactive user message system and method

(76) Inventor: Phillip D. Garding, North Bend, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/766,343

(22) Filed: Jan. 28, 2004

(51) Int. Cl. G06F 3/00

(52) U.S. Cl. 715/708; 715/705; 715/709; 715/710; 715/811; 715/810; 715/825; 715/843

(57) ABSTRACT

The present invention relates to an interactive user interface system and method. The interactive user interface system receives messages components in response to an event, such as an error, warning, or prompt, and provides one or more menu items or help links corresponding to respective message components in connection with addressing the event. Users can select a menu item or help link to receive or be directed toward helpful information or a remedy for the event. Furthermore, the interface system provides for capturing message components and other interface data so that it can easily be copied or transferred.

### TECHNICAL FIELD

The present invention relates generally to computers and more particularly toward graphical user interfaces.

### BACKGROUND

Computer systems often require user input and/or transmission of messages to users. For example, applications can request or prompt users for information such as “Save changes to Untitled Document?” or “Would you like to revert to the saved version?” Alternatively, applications can convey information concerning errors, such as informational errors, warnings, and fatal errors. An informational error can be triggered by a condition, such as “printer low on ink.” A warning or warning error can be caused by a correctable condition, such as a wireless network connection unexpectedly disconnecting or an abnormal termination of an application program, which could compromise system stability. Finally, a fatal error can be generated when an application is unstable and requires it to be closed or the system to be shut down.

Conventionally information is transferred and received between users and computer system applications utilizing graphically user interfaces (GUIs). In particular, modal message boxes displayed in the foreground of a display are often employed. Typically, such message boxes “pop-up” on a user's display when user input is required and remain there until the user reacts to the message shown in the message box. Users can react to displayed messages, conventionally, utilizing pointing devices (e.g., mouse, trackball) or a keyboard to select or activate provided buttons corresponding to particular actions or responses to inquires, such as save or cancel, yes or no, etc.

Unfortunately, presently available GUIs or message boxes are flawed in several respects. First, messages often provide users with cryptic information that is often undecipherable by users. Additionally, situations occur where the provided information is insufficient to designate an appropriate response with any degree of certainty. Furthermore, many times applications or systems utilize standardized messages for a multitude of different errors. Still further yet, conventional messages boxes are static and do not a user allow a user to retrieve any information that could be helpful in designating an appropriate response.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to an interactive user interface system and method that facilitates designating appropriate responses to system events. According to an aspect of the invention, the subject system and method receive message components upon the occurrence of an event. An event can correspond to any system happening that may require user notification or input from a user. For instance, an event can correspond to a warning or prompt that a printer is low on ink, that the system is low on memory, or inquiring into whether a user would like to save a file before closing. An event does not require an exception to be thrown.

According to an aspect of the subject invention, message components can comprise one or more messages and context and rationale components associated with each message. For example, a message may be generated in response to a user trying to retrieve a resource from a network. The context component can provide a user context for the message such as the message was generated upon execution of a command trying to receive a network resource. The rationale component can provide a user with a reason for the event associated with the message. For example, the network is not currently available. Messages received from the message component can then be displayed to a user in hierarchical fashion to facilitate understanding of the source and cause of an event.

A plurality of menu items can be generated corresponding to particular messages according to another aspect of the subject invention. Menu items can correspond to links that provide a user with a link or pointer to helpful information or a corrective action. Such information or corrective action can be found on a webpage or in a database locally or remotely associated with the interface system. The menu items can be accessed utilizing a pointing device such as a move to select the item. Furthermore, to facilitate selection of the appropriate menu item the system and method of the present invention can highlight the message portion corresponding to an item on which a pointer or cursor is hovering.

According to another aspect of the subject invention, an event message(s) can be captured and easily distributed to other people or applications. For example, upon selection of a particular graphical object, an event message can be captured and copied to a clipboard or other similar application for use by a plurality of other applications and/or printed out. Additionally, the subject invention allows event messages to easily be emailed to others. For instance, the subject invention can enable event message(s) to be copied to an email application for easy communication with others (e.g., friend, support personnel . . . ), upon the selection of an appropriate graphical object.

According to yet another aspect of the subject invention, menu items generated in response to messages can correspond to communication links to developers or software company databases. In other words, the subject system and method facilitate easy communication of feedback. For example, a user can send feedback by simply selecting a menu item that corresponds to a particular message.

According to still another aspect of the invention, the subject user interface can be utilized by a user to execute a command. For example, if a message indicates that a particular application is not running a user can issue a command to start the application from the interface via a graphical object such as a button or a menu item.

Furthermore and in accordance with an aspect of the invention, various graphical objects such as buttons, text boxes, scroll bars, drop down menus, and check boxes can be utilized by the subject invention to facilitate ease of use.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

The foregoing and other aspects of the invention will become apparent from the following detailed description and the appended drawings described in brief hereinafter.

FIG. 1 is a schematic block diagram of an interactive user message system in accordance with an aspect of the present invention.

FIG. 2 is a block diagram of a message component in accordance with an aspect of the subject invention.

FIG. 3 is a block diagram of a message component in accordance with an aspect of the subject invention.

FIG. 4 illustrates an exemplary display of messages associated with an event in accordance with an aspect of the present invention.

FIG. 5 illustrates a graphical user interface in accordance with an aspect of the present invention.

FIG. 6a depicts a graphical user interface in accordance with an aspect of the subject invention.

FIG. 6b illustrates a graphical user interface in accordance with an aspect of the subject invention.

FIG. 7 depicts a graphical user interface in accordance with an aspect of the present invention.

FIG. 8 illustrates a graphical user interface in accordance with an aspect of the subject invention.

FIG. 9 illustrates a graphical user interface in accordance with an aspect of the present invention.

FIG. 10 is a flow chart diagram of a methodology for providing an interactive graphical user interface in accordance with an aspect of the subject invention.

FIG. 11 is a flow chart diagram of a methodology for providing an interactive graphical user interface in accordance with an aspect of the present invention.

FIG. 12 is a schematic block diagram illustrating a suitable operating environment in accordance with an aspect of the present invention.

FIG. 13 is a schematic block diagram of a sample-computing environment with which the present invention can interact.

### DETAILED DESCRIPTION

The present invention is now described with reference to the annexed drawings, wherein like numerals refer to like elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. Of course, those skilled in the art will recognize many modifications may be made to this configuration without departing from the scope or spirit of the subject invention.

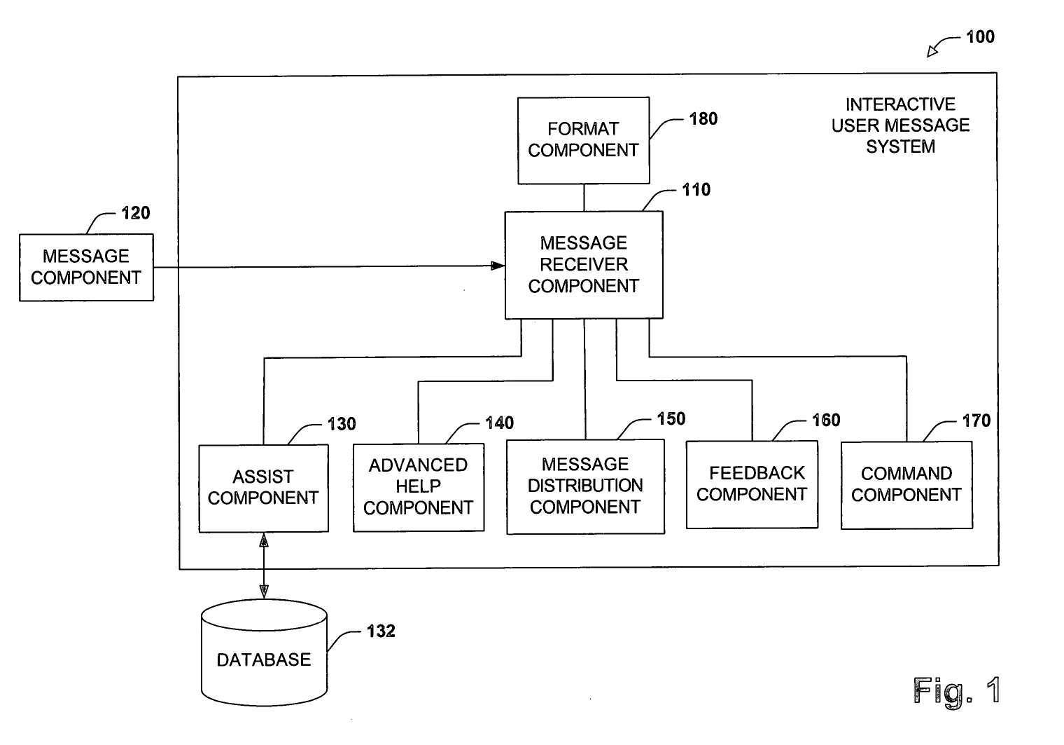

Turning to FIG. 1, an interactive user message system 100 is depicted in accordance with an aspect of the present invention. The system 100 comprises receiver component 110, assist component 130, advanced help component 140, event information distribution component 150, feedback component 160, command component 170, and format component 180. Receiver component 110 receives message component(s) 120. Message component(s) 120 includes one or more messages associated with events. Events include but are not limited to errors, a determination of potential for error (e.g., warning), or any situation in which a system requires user input (e.g., prompts). For instance, an error can occur when an application tries to open a file or application (e.g., spreadsheet, text document, web page . . . ) that is not available. A warning can occur upon a determination that system memory is low, and a prompt may be utilized to determine whether a user wishes to overwrite another file, for example. Furthermore, messages associated with errors can describe, for example, the source and cause of an error.

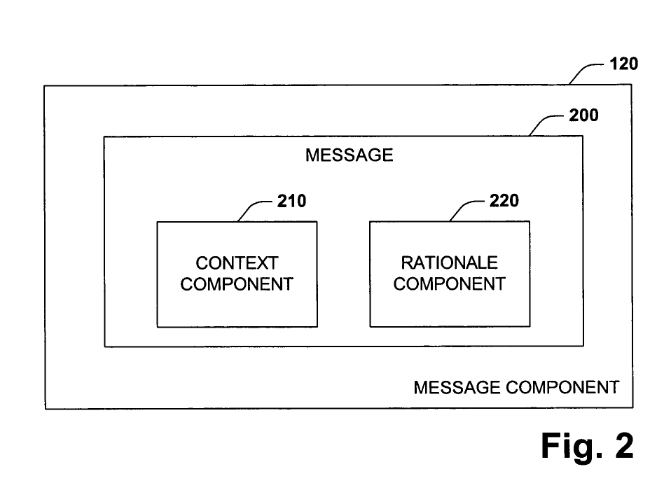

Turning to FIG. 2, a message component 120 is illustrated according to an aspect of the subject invention. Message component 120 comprises at least one message 200 comprising a context component 210 and a rationale component 220. It is to be appreciated that more than one part of an event such as an error is usually necessary for a user to understand a failure. In particular, context component 210 can give a user context to understand what operation failed, while the rationale component 220 can explain the reason for the failure. Conventionally, tools often reported only the detailed message information without giving the user context or vice versa. Providing a user with command context, for instance, is important because it relates directly to the user's actions. At times a user may execute a command that results in several steps. If one step fails, and only the low level or detailed report of a failure is shown, it is ambiguous as to which step failed. Another area of confusion is that an underlying failure may not be fatal to the command or to all of the command, so an error message can be displayed but then the command appears to be successful. Additionally, sometimes a command is executing asynchronously, so a user may be working on something else when the error occurs and the message is displayed. Providing user-context information makes the message much clearer and reduces the potential for user confusion.

Parts of a multipart message can be stored and represented as different strings stored in different places. The client system that invokes the message dialog typically knows the context of the user action, so it can provide a user-context string from amongst its resources. An exception object, error code, or message string from the lower level service can come from middleware or server resources, for example. The system of the present invention receives and handles each part of multi-part messages and displays them appropriately.

At times the highest level message may be sufficient for users to understand an event; at other times, the lowest level information is needed to understand the root cause of a problem. According to an aspect of the subject invention, messages can contain multiple levels of information. For example, if an error occurs, a message can contain the status of the command or part of the command a user was performing (e.g., connect to server, create database . . . ) and the reason for the error or failure of the command. Furthermore, the failure can also contain multiple levels of information. For instance, a server may report a failure that came from an underlying operating system or service failure.

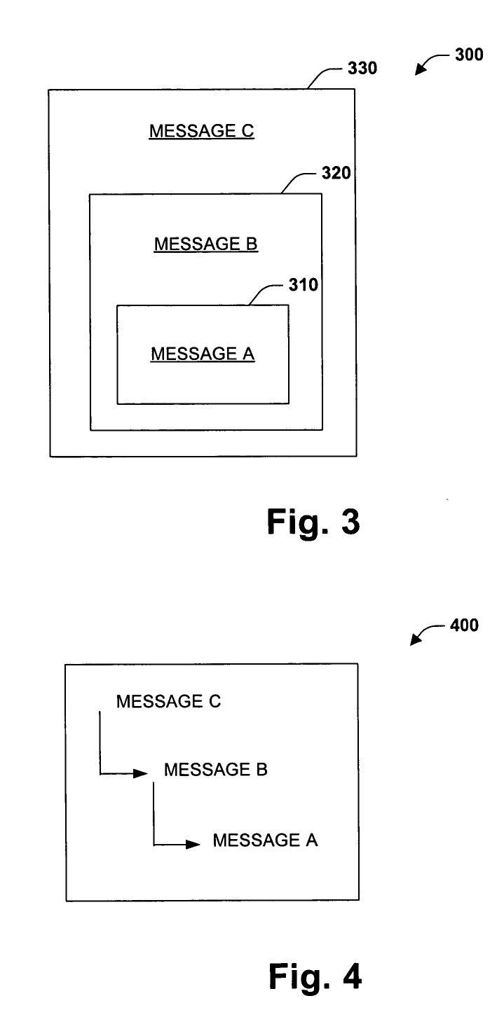

FIG. 3 graphically depicts a message component 300 in accordance with an aspect of the subject invention. As is illustrated, message component object has three hierarchical layers of messages 310, 320, and 330. From the top to the bottom of the hierarchy (330-310), the messages can contain increasingly detailed messages about the source of an error. For purposes of clarity and understanding and not limitation, an example will now be described relating to a primary application that utilizes a server. First, there is an error occurs with the primary server application that indicates a problem with a server agent. The primary application subsequently contacts the server agent application to determine the problem with the server agent. The server agent application can then produce an exception and a message A 310 such as “server agent not running so it can not be notified of this action.” A connection application catches the server agent exception wraps it, throws its own exception and adds a message B 320 indicating a batch or execution statement failure. Finally, the primary application catches the group of messages and wraps it with its own message C 330 indicating that a server could not start because some required application, such as a server agent, was not running. Thus, a message component can be hierarchical in nature, where the messages from the outside in describe with increasing specificity the root cause of an error. The subject interface can receive a plurality of hierarchical messages and display them to a user to facilitate understanding of an event. For example, a message system of the present invention could display messages as is illustrated in FIG. 4.

FIG. 4 illustrates an exemplary display 400 corresponding to the example utilized above concerning the potential composition of a message component 120. Exemplary display 400 utilizes arrows and message positioning to facilitate easy identification of the hierarchical nature of the messages. The top message, message C is a high level description of an event's context and rationale, while the bottom message, message A, is a lower level description of the event, such as the cause of an error. Of course, a message component does not have to have a plurality of messages, thus the display can contain only a single message. Furthermore, it is to be appreciated that there are many ways to present users with hierarchical or other data to facilitate understanding of such information. Additional ways of presenting users with data will be apparent to those of skill in the art upon reading this application, and such additional presentations or displays are considered within the scope of the present invention.

Returning to FIG. 1, the receiver component 110 receives the message component 120 into the interface system 100 and passes it to the assist component 130. Upon receipt of the message component 120, assist component 130 generates a plurality of menu items corresponding to respective messages of message component 120 in connection with addressing events. According to one aspect of the subject invention, each menu item can contain a link to a database or webpage which provides information or a corrective action with respect to the associated message. Accordingly, upon selection of one of the links the assist component 130 can construct a URL (uniform resource locator), or otherwise locate a web page address associated with a particular event message, and open a browser to display the web page associated with the generated URL or address and an event message. As mentioned, help information can be retrieved from a database(s) 132 located proximate to or remotely from the interface system 100. Upon selection of a help link or topic associated with an event message, the assist component 130 can construct a query of the database(s) 132 based on the particular database schema and the event message. The assist component 130 can then retrieve information from the query and display it to the user in an appropriate format (e.g., as webpage in web browser, text in a note pad, video or sound in an associated multimedia player . . . ). Furthermore, it should be noted that what is returned by a linked web page or queried database need not simply be information related to the event message. For example, if the event is an error, the help component could provide a link to a fix (e.g., patch) for the error if known.

Turning to FIG. 5, a graphical user interface 500 is illustrated in accordance with an aspect of the subject invention. Interface 500 depicts a prompt for confirming deletion of a file with a single message 510. Interface 500 further comprises a graphical object 520 to activate an assist component, which can provide a help menu containing one or more links to help information associated with the message 510. Furthermore, graphical objects 530 can be provided to initiate message distribution (e.g., copy to clip board, email) as described in further detail in the following sections. Finally, the interface 500 can include buttons 540 to enable a user to confirm or disaffirm deletion of a file in the present instance using a “Yes” button or a “No” button.

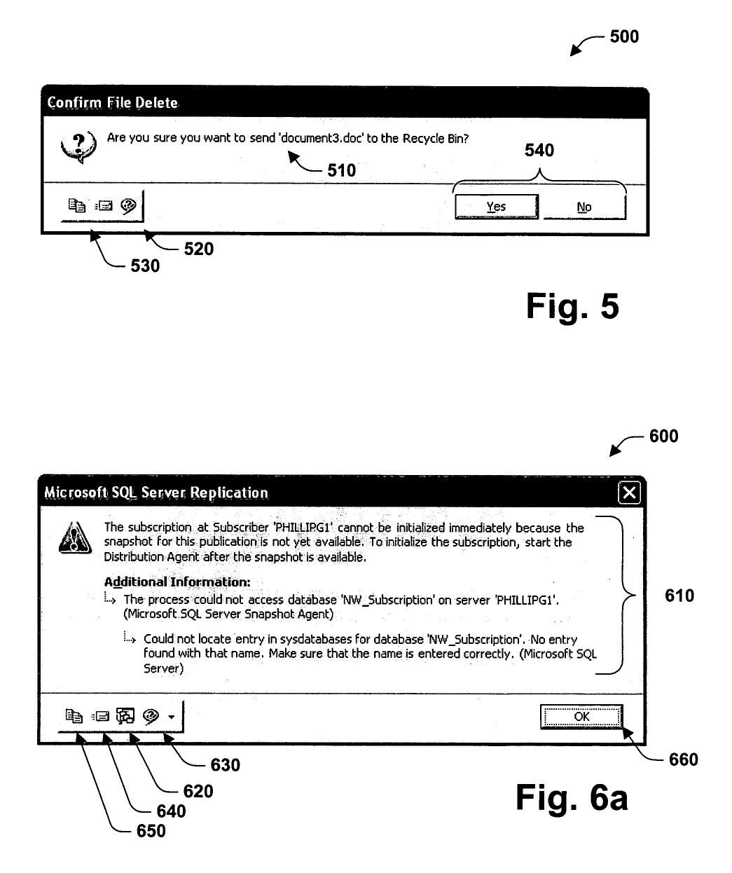

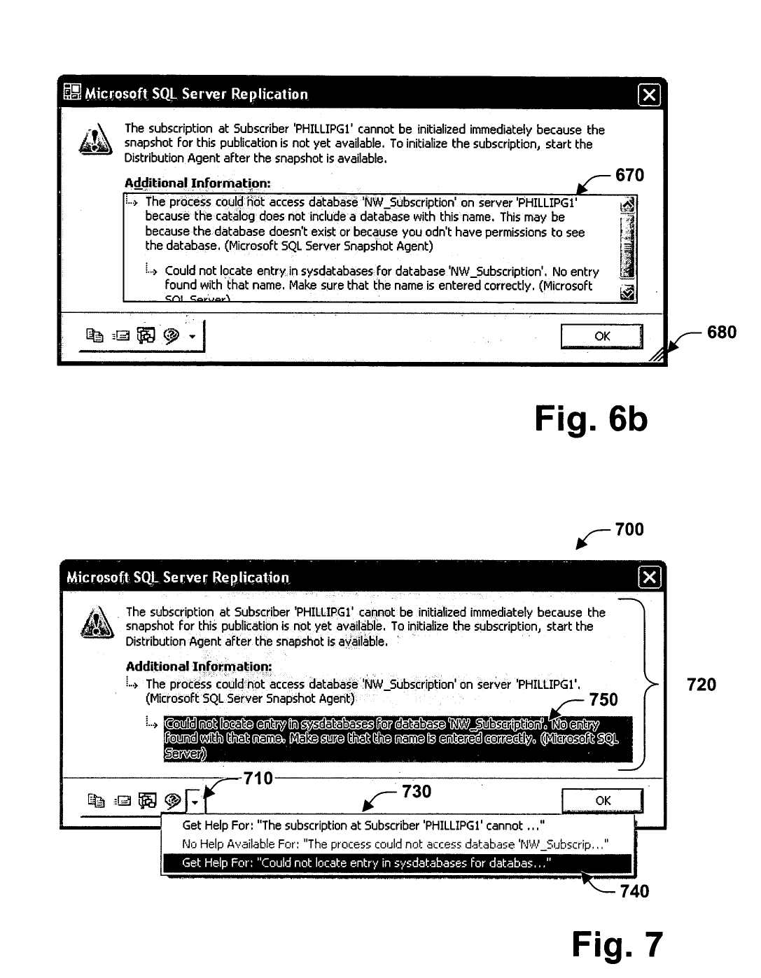

FIG. 6a illustrates a graphical user interface 600 in accordance with an aspect of the subject invention. Interface 600 illustrates a message interface including display of a plurality of messages 610. As described above, the messages 610 can be displayed, as a hierarchical list where the first message describes the event at the highest level and the last message reveals more technical details concerning the event. According to an aspect of the invention, the first part of the highest level message can be display first with other messages following in what can be labeled an additional information section. Furthermore, a graphical object such as button 620 can hide lower level additional messages (not shown) upon activation by a pointer device (e.g., mouse, trackball, stylus, touch pad . . . ), for example. Additionally user interface 600 can include graphical objects for initiation of user assistance 630 as well as message dissemination such via email 640 and copying to a clipboard 650, for instance. Furthermore, user interface 600 can include one or more buttons 660 for responding to presented message(s).

Turning briefly to FIG. 6b, it should be noted that if there are a large number of event associated messages to display, or if the length of the message or messages is more than can be comfortably shown in the user interface, then the lower level messages can be displayed in a scrollable text box 670. Additionally or alternatively the graphical interface box can be enlarged or shrunk to fit all the message text, for instance, by utilizing zoom object 680 and a pointing device to change the size of the interface box. For example, by clicking and dragging the interface box corner to resize the display.

FIG. 7 depicts a graphical user interface 700 in accordance with an aspect of the present invention. Interface 700 illustrates an exemplary dialog box display and use of the assist component 130 (FIG. 1). Accordingly, a user can click on the graphical button object 710 to search for help regarding one of the three displayed messages 720. Upon activation of button 710 a drop down menu 730 can appear containing menu items to facilitate getting help with the displayed messages 720. As illustrated the links can be in the form of “Get help for:” appended with at least a portion of the message with which it is associated. To further facilitate accurate selection of the appropriate help information the interface 700 can also highlight the message associated with a menu item or help link a user is considering selecting from the help menu 730, for example when they hover over the help link utilizing a pointing device. Thus, if a user hovers over help link 740 with their mouse, for instance, then message 750 from the hierarchy of messages 720 can also be highlighted. Furthermore, it should be noted that help information may not be available for every message or any message for that matter. In such a situation the drop down menu 730 can simply not display a link or alternatively simply indicated that no help information is available and disable it from being selected, as is illustrated with respect to the second message.

Returning to FIG. 1, interactive interface 100 can also include advanced assist or help component 140. Advanced help component 140 can provide more detailed or technical information for advanced users or support personnel. In particular advanced help component can, according to one aspect of the invention, provide a stack trace where an exception was thrown. This information is of no real use to the typical end user; however the information can be very helpful to a developer or support personnel when they are trying to understand where in the code an error originated. A graphical object such as a button on the interactive interface component 100 can be utilized to commence advance help component functionality (e.g., help button 630 of FIG. 6a). Furthermore, although advance help component 140 is illustrated separate from assist component 130 it should be appreciated that the functionality of advanced help component 140 could reside with assist component 130.

Interactive user message system 100 can also include a message distribution component 150. Conventionally when messages such as prompts, warnings and errors occur there is no mechanism to easily retrieve the message text from the interface that displays it. Often times, a user seeking help in a conventional manner needs to either manually write the message down, perform a screen capture and save the image, or simply remember the message so that they can communicate the message to other people such as support personnel. Message distribution component 150 captures or retrieves message text from the graphical user interface and provides it to a designated system or application. According to one aspect of the subject invention, the message distribution component 150 can be utilized to copy the message text to a clipboard or some other application such as a word processing application. Alternatively and according to another aspect of the present invention, the message distribution component 150 can be employed to capture message text, invoke an email application (e.g., Microsoft Outlook), create a new email, and copy the message text to the body of the email. The message distribution functionality can be initiated utilizing graphical objects on the user interface (e.g., 640 and 650 of FIG. 6a) and/ or via short cut keys, such as Ctrl+C, for example. When information is copied or captured by message distribution component 150 some or all of the following information can be included: the message box caption, the text for all message parts, the URL or address for help, and the text of the selectable buttons. For example:

TITLE: Microsoft SQL Server Replication
----------------------------------------
The subscription at Subscriber ‘PHILLIPG1’ cannot be
initialized immediately because the snapshot for this
publication is not yet available. To initialize the
subscription, start the Distribution Agent after the snapshot
is available.
For help, click:
http://www.microsoft.com/events.asp?ProdName=
Microsoft%20SQL%20Server&ProdVer=5402&msgsrc=CreatePubWizard.
dll&msgid=CantInitSubscription
----------------------------------------
ADDITIONAL INFORMATION:
The process could not access database ‘NW_Subscription’ on
server ‘PHILLIPG1’. (Microsoft SQL Server Snapshot Agent)
----------------------------------------
Could not locate entry in sysdatabases for database
‘NW_Subscription’. No entry found with that name. Make sure
that the name is entered correctly.
http://www.microsoft.com/events.asp?ProdName=
Microsoft%20SQL%20Server&ProdVer=5402&msgsrc=MSSQLServer&msgi
d=57889
----------------------------------------
BUTTONS:
OK
Try Again
Start Snapshot Agent
----------------------------------------

Furthermore, technical details produced by the advanced help component 140 can also be copied or emailed in same general manner as described with respect to the general event messages that a user can copy or email. The only difference is the data that will be copied or displayed. Technical details that can be copied, emailed, or otherwise distributed by message distribution component 150 can include and be displayed as follows:

TITLE: Advanced Information
----------------------------------------
TITLE: Sql Workbench
----------------------------------------
Create failed for Database ‘[AdventureWorks]’. (Microsoft.SqlServer.Smo)
For help, click:
http://www.microsoft.com/products/ee/transform.aspx?ProdName=Microsoft SQL
Server&ProdVer=9.00.730.00&EvtSrc=Microsoft.SqlServer.Management.Smo.Exceptio
nTemplates.FailedOperationExceptionText&EvtID=Create+Database
---------------
Program Location:

at Microsoft.SqlServer.Management.Smo.SqlSmoObject.CreateImpl( )
at Microsoft.SqlServer.Management.Smo.DatabaseBase.Create( )
at

Microsoft.SqlServer.Management.SqlManagerUI.CreateDatabaseData.DatabasePrototyp
e.ApplyChanges( )

at

Microsoft.SqlServer.Management.SqlManagerUI.CreateDatabase.DoPreProcessExecutio
n(RunType runType, ExecutionMode& executionResult)

at

Microsoft.SqlServer.Management.SqlMgmt.SqlMgmtTreeViewControl.DoPreProcessEx
ecutionAndRunViews(RunType runType)

at

Microsoft.SqlServer.Management.SqlMgmt.SqlMgmtTreeViewControl.ExecuteForSql(P
reProcessExecutionInfo executionInfo, ExecutionMode& executionResult)

at

Microsoft.SqlServer.Management.SqlMgmt.SqlMgmtTreeViewControl.Microsoft.SqlSer
ver.Management.SqlMgmt.IExecutionAwareSqlControlCollection.PreProcessExecution(
PreProcessExecutionInfo executionInfo, ExecutionMode& executionResult)

at

Microsoft.SqlServer.Management.SqlMgmt.ViewSwitcherControlsManager.RunNow(Ru
nType runType, Object sender)
----------------------------------------
ADDITIONAL INFORMATION:
An exception occurred while executing a SQL statement or batch.
(Microsoft.SqlServer.ConnectionInfo)
---------------
Program Location:

at

Microsoft.SqlServer.Management.Common.ServerConnection.ExecuteNonQuery(String
sqlCommand, ExecutionType executionType)

at

Microsoft.SqlServer.Management.Common.ServerConnection.ExecuteNonQuery(String
Collection sqlCommands, ExecutionType executionType)

at

Microsoft.SqlServer.Management.Common.ServerConnection.ExecuteNonQuery(String
Collection sqlCommands)

at

Microsoft.SqlServer.Management.Smo.ExecutionManager.ExecuteNonQuery(StringColl
ection queries, Boolean bUseMaster)

at

Microsoft.SqlServer.Management.Smo.SqlSmoObject.ExecuteNonQuery(StringCollectio
n queries)

at

Microsoft.SqlServer.Management.Smo.SqlSmoObject.CreateImplFinish(StringCollection
createQuery, ScriptingOptions so)

at Microsoft.SqlServer.Management.Smo.SqlSmoObject.CreateImplWorker( )
at Microsoft.SqlServer.Management.Smo.SqlSmoObject.CreateImpl( )

----------------------------------------
Database ‘AdventureWorks’ already exists. (.Net SqlClient Data Provider)
For help, click:
http://www.microsoft.com/products/ee/transform.aspx?ProdName=Microsoft%20SQL%
20Server&ProdVer=09.00.0000.00&EvtSrc=MSSQLServer&EvtID=1801
---------------
SQL Server Information
Error Number: 1801
Severity: 16
State: 3
Line Number: 1
---------------
Program Location:

at System.Data.SqlClient.SqlCommand.ExecuteNonQuery( )
at

Microsoft.SqlServer.Management.Common.ServerConnection.ExecuteNonQuery(String
sqlCommand, ExecutionType executionType)
----------------------------------------
BUTTONS:
OK
----------------------------------------
For help, click:
http://www.microsoft.com/events.asp?progname=MicrosoftSqlServer&pr
ogver=9.0&msgsrc=CreatePubWizard.dll&msgid=CantStartSnapshotAge
nt
----------------------------------------
BUTTONS:
OK
----------------------------------------

The message interface of the present invention can also include a feedback component 160. Many times software companies and their developers are interested in feedback from users. For example, during a beta release of an application developers are interested in learning of the bugs their application contains. Additionally, some companies maintain large databases containing errors received and sent to them by users of their products so that the reported errors can be corrected in future products or patched. The feedback component 160 provides a mechanism to send developers and companies feedback related to one or more event messages. FIG. 8 provides an exemplary user interface 800 illustrating the use of a feedback component in accordance with an aspect of the subject invention. Interface 800 provides a button 810 which can be activated if and when a user desires to send feedback to an entity such as a software developer or software company regarding event messages 820. Upon activation (e.g., hovering a cursor) of the button 810 a drop down menu 830 can appear. Drop down menu 830 provides selectable descriptions of the messages listed above for which feedback can be sent. Upon selection of one the drop down menu items all or part of the information associated with the selected message will be sent to a designated individual or entity. Furthermore, to facilitate accurate selection of a drop down menu item, the particular event message associated with an activated drop down menu item can be highlighted. Activation can occur upon selection and/or while hovering a cursor over a particular item. Furthermore, it should be noted that like all components, systems, and features described herein the feedback component and the assist component are not mutually exclusive. Accordingly, a button 840 can be provided on interface 800 which includes assist component functionality. According to one aspect of the present invention, button 840 can be drop down menu with selectable items to initiate functionality associated with the assist component 130, advanced help component 140, and message distribution component 150, as well as command component 170.

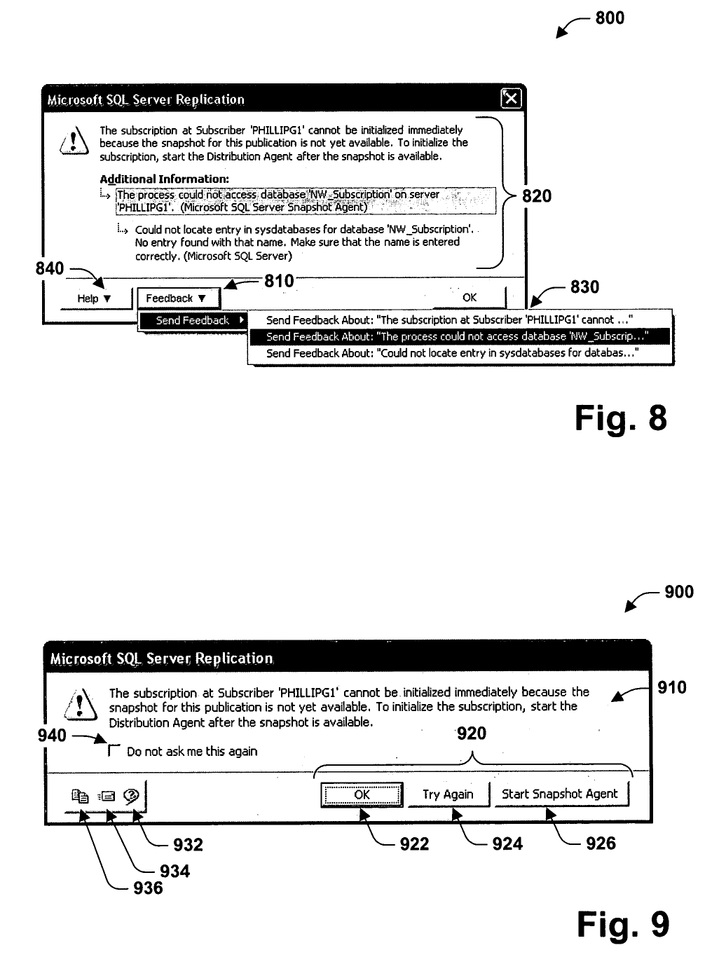

Command component 170 of user message system 100 provides a mechanism for issuing commands. The present invention is not limited to simply retrieving help information related to event messages. The system can also be employed to initiate corrective action. For instance, the command component can inform a client that a user desires to execute a particular command. Turning to FIG. 9 a messaging interface 900 is illustrated in accordance with an aspect of the subject invention. Messaging interface 900 contains and event message 910. The message indicates that a subscription can not be initialized because an application or module, here the snapshot agent, has not been started. The interface 900 also contains buttons 920 named “Ok,” “Try Again,” and “Start Snapshot Agent.” Accordingly a user viewing this interface can select the “OK” button 922 to acknowledge the error message and quit, try to initialize the subscription again by clicking on “Try Again” button 924, or alternatively and in accordance with an aspect of the invention, a user can activate “Start Snapshot Agent” button 926. Activation or selection of button 926 informs a client, here Snapshot Agent, that a user desires to issue a command, for instance, by reporting to the client that a particular button was pressed. The client can then issue the appropriate command, in accordance with the users input. Here, the Snapshot Agent will be notified that a user wishes to start the application. The Snapshot Agent can then start up thereby correcting the error described in the event message 910. Furthermore, it should be noted that a user could employ the functionality associated with selectable button icons 932-936 prior to selection of one of the buttons 920. For example, a user could click on button 932 to direct the user toward useful help information associated with the event message 910. Additionally or alternatively, the user could select buttons 934 and/or 936 to copy the text message or email the text message to someone, respectively, in order to obtain information or help associated with the event message 910.

Still further yet, interface 900 can contain a checkbox graphical object 940, which can be checked, for instance, if the user does not want to see the event message 910 again. If checkbox 940 on the interface is checked (e.g., upon selection by a pointing device such as a mouse), the interface 900 can store the information and action associated with the checkbox such that if the event message 910 is generated in the future the message is not displayed to the user per the user's request upon checking box 940. According to an aspect of the subject invention, the checkbox 940 checked state can be linked to a registry key and value. Initially the checkbox can be initialized to a non-zero value. When the interface containing the checkbox is dismissed, a 1 or 0 value can be written to the check box registry value based on the state of the checkbox. For example, if the checkbox is used for a “do not shown this message” value, then the client can have the interface system determine for itself whether to display the interface based on the value of the registry. This allows the full logic for a check box to reside in the message system, where a client need only provide the registry location and the default return value if the message is not displayed. However, the client can also instruct the message interface system to ignore the registry value, for instance if a registry key is provided.

Returning to FIG. 1, the user message system 100 of the present invention can also contain a format component 180. Format component 180 can include data as to the format of the displayed user interface. Format component 180 can receive information regarding the client specified format from receiver component 110. The graphical user interface provided to a user for a given set of message events can be formatted as specified by a client via the message component or by some other means. Graphical user interfaces formats can ultimately be specified in almost an infinite number of ways. For example, there can be any number graphical objects such as buttons, checkboxes, text boxes, scroll bars, drop down menus, icons, and the like. Buttons can be customized and named almost anything. Most often, however, buttons include text such as “OK,” “Cancel,” “Yes,” “No,” “Abort,” “Retry,” and “Ignore.” Furthermore, checkboxes can have almost any text string associated therewith. Additionally, graphics or icons can be displayed in and interface to indicate warnings, information, or errors to name but a few. Particular icons that can be utilized include but are not limited to an exclamation point, an asterisk, a question mark, a hand, and a stop sign. Still further yet, activation, selection, or interaction with graphical objects can be accomplished in a variety of different ways including utilizing a pointing device (e.g., mouse, stylus, trackball, touchpad, touch screen . . . ) and/or utilizing a keyboard or other input device. Accordingly it should be appreciated that the graphical user interfaces of FIGS. 5-9 are merely exemplary and could have been organized in a number of other ways utilizing different, more, or less graphical objects.

Furthermore, it should be appreciated that even though this user message interface system can utilize web browsers, for instance, to display help information that does not exclude web browsers from being able to take advantage of the present interface system. In fact any computer application can employ the system and method of the present invention.

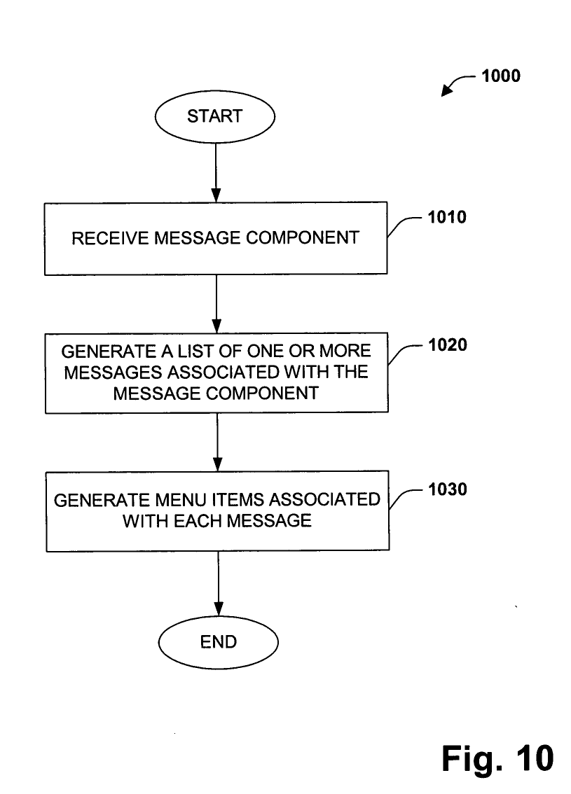

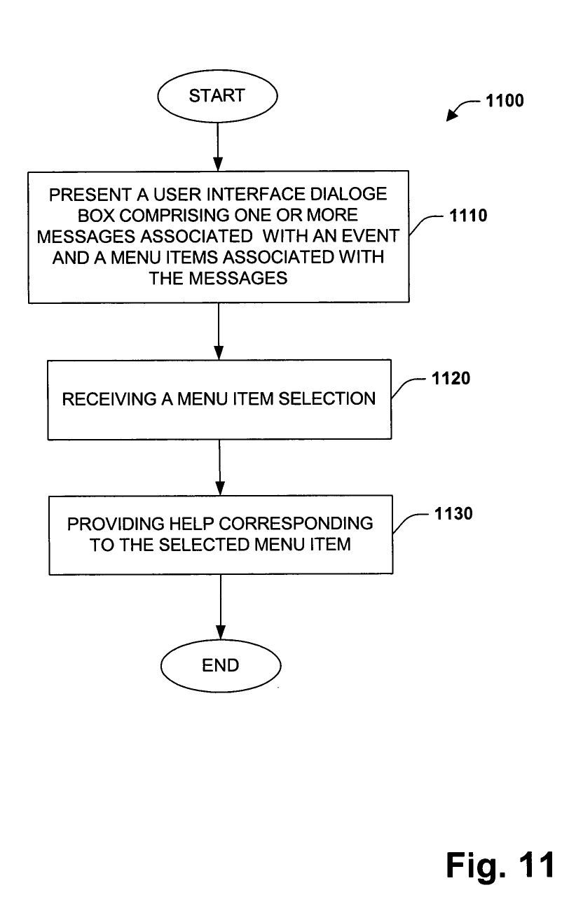

In view of the exemplary system(s) described supra, a methodology that may be implemented in accordance with the present invention will be better appreciated with reference to the flow charts of FIGS. 10-11 . While for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

FIG. 10 is a flow chart diagram of a methodology 1000 for interacting with a user upon the occurrence of an event in accordance with an aspect of the subject invention. At 1010, a message component is received. The message component can contain messages regarding the cause and reason for an event. The message component can also contain format information concerning how the message will be displayed to a user as well as which functions will be available. At 1020, a list of the messages received from the message component are generated, formatted, and displayed. In accordance, with an aspect of the subject invention the list can be a linked list with messages organized hierarchically based, for example, on the level of detail of the message and/or temporal order of occurrence. Subsequently, a list or menu of items, such as help links, associated with each message can be generated, at 1030. The help links may link a user to a particular Internet website or database located proximate or remotely from the user. The help links can provide links to help information (e.g., web site, text, video, sound) and/or corrective measures (e.g., service patch).

FIG. 11 is a flow chart diagram of a methodology 1100 for interacting with users is depicted in accordance with an aspect of the subject invention. At 1110, a user interface dialog box is presented comprising one or more messages associated with an event and a list or menu of items associated with the messages is presented. A menu of items can include but are not limited to links to a database or website that can provide information or help regarding a message. If no help or information is available concerning a particular message such status can be displayed or denoted. Furthermore, other graphic objects can be presented or displayed such as one or more buttons or checkboxes for receiving information from a user and/or initiating particular functionality such as capturing message text for copying or email to another entity or person (e.g., friend, developer, support personnel . . . ). At 1120 a menu item selection is received. This can correspond to a user selecting a help link from the menu. Subsequently, help can be provided to the user based on the item or link selected at 1130. Help can be of any kind including but not limited to information, data, or a corrective measure. Furthermore, the help can be technical in nature targeted toward developers or support personnel. For example, the help can include a stack trace for determining the cause of an error.

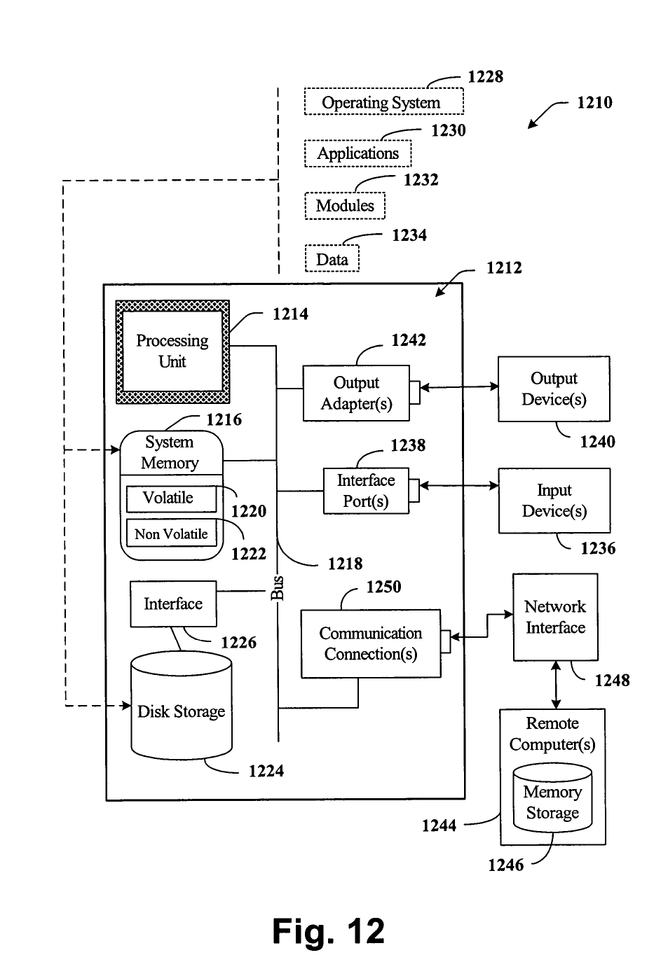

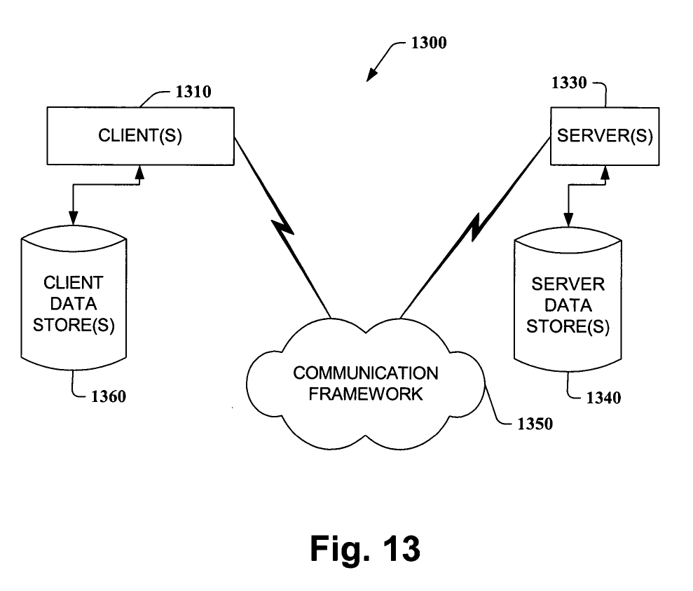

In order to provide a context for the various aspects of the invention, FIGS. 12 and 13 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example disk storage 1224. Disk storage 4124 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

FIG. 13 is a schematic block diagram of a sample-computing environment 1300 with which the present invention can interact. The system 1300 includes one or more client(s) 1310. The client(s) 1310 can be hardware and/or software (e.g., threads, processes, computing devices). The system 1300 also includes one or more server(s) 1330. The server(s) 1330 can also be hardware and/or software (e.g., threads, processes, computing devices). The servers 1330 can house threads to perform transformations by employing the present invention, for example. One possible communication between a client 1310 and a server 1330 may be in the form of a data packet adapted to be transmitted between two or more computer processes. The system 1000 includes a communication framework 1350 that can be employed to facilitate communications between the client(s) 1310 and the server(s) 1330. The client(s) 1310 are operably connected to one or more client data store(s) 1360 that can be employed to store information local to the client(s) 1310. Similarly, the server(s) 1330 are operably connected to one or more server data store(s) 1340 that can be employed to store information local to the servers 1330.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An interactive user messaging system comprising:
a receiver component that receives message components corresponding to events; and
an assist component that provides one or more menu items corresponding to the respective message components in connection with addressing the events.

2. The system of claim 1, the message component comprising a context component that describes errors related to a user command

3. The system of claim 2, the message component comprising a rationale component that provides a reason for the error.

4. The system of claim 1, further comprising an advanced help component for providing technical information about events.

5. The system of claim 4, wherein the technical information is a stack trace.

6. The system of claim 1, further comprising a message distribution component for capturing message text.

7. The system of claim 6, wherein the message text is copied to a clipboard for further use by other applications.

8. The system of claim 6, wherein the message text is copied to the body of a new email message.

9. The system of claim 1, further comprising a feedback component that provides a message corresponding to an event to a developer or company database.

10. The system of claim 1, further comprising a command component that receives a command instruction from a user.

11. The system of claim 10, wherein the command informs a client that a user desires to issue a particular command.

12. The system of claim 1, further comprising a format component for receiving information regarding graphical objects and associated functionality that are to be available to a user.

13. An interactive user message display system comprising:
a means for receiving one or more messages corresponding with operation events; and
a means for associating help links with the one or more messages.

14. The system of claim 13, further comprising means for copying message text from the display system for use with other systems or applications.

15. The system of claim 13, wherein the help links are links to web pages containing specific information related to the message.

16. A method for providing users with help associated with computer system events comprising:
receiving a message component;
generating a list of one or more messages retrieved from the message component; and
generating menu items associated with each message in the list of messages.

17. The method of claim 16, wherein the list of messages is a hierarchical linked list.

18. The method of claim 16, wherein the menu items are help links to web pages comprising information related to a particular message.

19. The method of claim 16, wherein the menu items generate a query for a database.

20. A computer readable medium having stored thereon computer executable instructions for carrying out the method of claim 16.

21. A method of interacting with program users comprising:
presenting a user interface dialog box including one or more messages associated with an event and a menu of items associated with the messages;
receiving a menu item selection; and
providing help corresponding to the selected item.

22. The method of claim 21, wherein the messages are displayed hierarchically from the least specific to the most detailed.

23. The method of claim 21, wherein providing help include linking a user to web pages with help information.

24. The method of claim 21, wherein providing help includes retrieving information from a database.

25. The method of claim 21, wherein providing help includes providing a pointer to a corrective mechanism.

26. The method of claim 21, wherein providing help includes correcting an error.

27. The method of claim 21, wherein providing help includes generating a stack trace.

28. The method of claim 21, further comprising capturing the message text.

29. The method claim 28, further comprising opening a new email and copying the captured message text to the body of the email.

30. A computer readable medium having stored thereon computer executable instructions for carrying out the method of claim 21.
